(19) United States
(12) Patent Application Publication
(10) Pub. No.: US 2014/0081591 A1
(43) Pub. Date: Mar. 20, 2014

(54) TRANSIENT APPLICATIONS OF HEAT FLUX BIFURCATION IN POROUS MEDIA

(71) Applicant: Kambix Innovations, LLC, Albuquerque, NM (US)

(72) Inventors: Kambiz Vafai, Mission Viejo, CA (US); Kun Yang, Wuhan (CN)

(73) Assignee: Kambix Innovations, LLC, Albuquerque, NM (US)

(21) Appl. No.: 14/031,278

(22) Filed: Sep. 19, 2013

Related U.S. Application Data
(63) Continuation of application No. 13/590,435, filed on Aug. 21, 2012.
(60) Provisional application No. 61/598,060, filed on Feb. 13, 2012.

(51) Int. Cl. G01N 25/00

(52) U.S. Cl. CPC G01N 25/00
USPC 702/136

(57) ABSTRACT

A method and system for analyzing transient thermal response of a packed bed under Local Thermal Non-Equilibrium is disclosed. Heat transfer performances in terms of the fluid, solid, and total Nusselt number are obtained. Qualitative analyses of the effects of thermal conduction at the wall on the total heat exchange between the solid and fluid phases within the heat flux bifurcation region are also performed. Both the transient and diffusion aspects are considered in the solid and fluid phases along with the convection and the fluid-solid interaction. The analytical solution for transient response of a packed bed subject to a constant temperature boundary condition is derived. The heat flux bifurcation phenomenon in a porous media is investigated for temporal conditions, and the analytical two-dimensional thermal behavior and the LTE model is examined under transient conditions. Further, the response time towards steady state conditions is investigated.

### CROSS-REFERENCE TO PATENT APPLICATIONS

This patent application is a continuation of U.S. Nonprovisional patent application Ser. No. 13/590,435, entitled “Manipulating Heat Flux Bifurcation and Dispersion Inside Porous Media for Heat Transfer Control,” which was filed on Aug. 21, 2012 and is incorporated herein by reference in its entirety. U.S. Nonprovisional patent application Ser. No. 13/590,435 claims priority to U.S. Provisional Patent Application Ser. No. 61/598,060, which was filed on Feb. 13, 2012. This patent application therefore traces its priority date to the Feb. 13, 2012 filing date of U.S. Provisional Patent Application Ser. No. 61/598,060, and further incorporates by reference U.S. Provisional Patent Application Ser. No. 61/598,060 in its entirety.

### FIELD OF THE INVENTION

Embodiments are generally related to heat flux bifurcation in a porous media. Embodiments also relate to method and system for analyzing transient thermal response of packed bed under Local Thermal Non-Equilibrium (LTNE) conditions. Embodiments are additionally related to an exact solution for transient aspects of heat flux bifurcation in a porous media.

### BACKGROUND

Porous media are used to transport and store energy in many industrial applications such as heat pipe, solid matrix heat exchangers, electronic cooling, and chemical reactors. For a solar collector with air or water as the working fluid, a porous medium can provide an effective means for thermal energy storage. During the period of charging and recovery, transient thermal response aspects of the process for the packed bed are of major concerns.

Local Thermal Equilibrium (LTE) and LTNE models are the two primary ways for representing heat transfer in a porous medium. Although LTE model is more convenient to use, more and more studies have suggested that LTE model is not valid for some problems such as storage of thermal energy, or heat transfer in a porous media with internal heat generation. In these cases, the LTNE model is used for solid and fluid phases in porous media. See Lee, D. Y., and Vafai, K., 1999, “Analytical Characterization and Conceptual Assessment of Solid and Fluid Temperature Differentials in Porous Media,” Int. J. Heat Mass Transfer, 42, pp. 423-435, Alazmi, B., and Vafai, K., 2002, “Constant Wall Heat Flux Boundary Conditions in Porous Media under Local Thermal Non-Equilibrium Conditions,” Int. J. Heat Mass Transfer, 45, pp. 3071-3087 and Amiri, A., Vafai, K., 1998, “Transient analysis of incompressible flow through a packed bed,” Int. J. Heat Mass Transfer, 41, pp. 4259-4279.

Many studies have focused on the transient flow and heat transfer in a porous media. Schumann, T. E. W., 1929, “Heat transfer: liquid flowing through a porous prism, J. Franklin Inst.,” 208. pp. 405-416 presented an early analytical solution for transient temperature distribution of a semi infinite porous prism that is initially at a uniform temperature and the sides of the prism were adiabatic. Using an LTNE model, in which the diffusion terms in both the transverse and axial directions were neglected, the fluid and solid temperatures were found as a function of the axial position and time.

Riaz, M., 1977, “Analytical solution for single- and two-phase models of packed-bed thermal storage systems,” J. Heat Transfer, 99, pp. 489-492, investigated the transient response of packed bed thermal storage system and compared the analytical solutions obtained from simplified LTE and LTNE models, in which Schumann results were used and the transient term in fluid phase was ignored. It is obvious that the transient term in fluid phase to be considered for many types of applications.

Spiga, G., Spiga, M., 1981, “A rigorous solution to a heat transfer two phase model in porous media and packed beds,” Int. J. Heat Mass Transfer, 24, pp. 355-364, analytically investigated the dynamic response of porous media and packed beds systems to an arbitrary time varying inlet temperature using a LTNE model, in which the diffusion terms in both the transverse and axial directions were neglected. The temperature response for step, ramp, and periodic varying inlet temperature were discussed.

Using a perturbation technique, Kuznetsov, A. V., 1994, “An investigation of a wave of temperature difference between solid and fluid phases in a porous packed bed,” Int. J. Heat Mass Transfer, 37. pp. 3030-3033, presented interesting and important aspects of the temperature difference between solid and fluid phases in a semi infinite packed bed based on a LTNE model, in which the diffusion terms in transverse directions in both the fluid and solid phases were neglected. Kuznetsov had established that the temperature difference between the fluid and solid phases forms a thermal wave localized in space.

Using the same technique, Kuznetsov, A. V., 1997, “A perturbation solution for heating a rectangular sensible heat storage packed bed with a constant temperature at the walls,” Int. J. Heat Mass Transfer, 40, pp. 1001-1006, presented an analytical solution for a packed bed subject to a constant temperature condition at the walls, in which the dimensionless solid phase temperature was considered to differ from the fluid phase temperature by a small perturbation. It was shown that the transient component of the temperature difference between the fluid and solid phases describes a wave propagating in the axial direction from the fluid inlet boundary.

Henda, R., Quesnel, W., Saghir, Z., 2008, “Analytical solution of the thermal behavior of a circulating porous beat exchanger,” Fluid dynamics and materials processing, 4, pp. 237-243, presented an analytical solution for the transient thermal behavior of a two dimensional circulating porous bed based on a LTE model. Their findings showed that the temperature propagates throughout the bed in a wave-like form and approaches steady state results for large values of time. Beasley, D. E., Clark. J. A., 1984, “Transient response of a packed bed for thermal energy storage, Int. J. Heat Mass Transfer,” 27, pp. 1659-1669, developed a numerical model to predict the transient response of a packed bed based on the LTNE model, in which the diffusion terms in both the transverse and axial directions in the solid phase were neglected. Their numerical results compared favorably with the experimental measurement of temperature distribution in a packed bed of uniform spheres with air as working fluid. Amiri and Vafai have presented a comprehensive investigation of the transient response within a packed bed. The temporal impact of the non-Darcian terms and the thermal dispersion effects on energy transport were investigated and the range of the validity for LTE condition was established.

Therefore, a need exists for revealing the phenomenon of analyzing transient thermal response of a packed bed under Local Thermal Non-Equilibrium (LTNE) condition and to obtain an exact solution for transient aspects of heat flux bifurcation in porous media.

### SUMMARY

The following summary is provided to facilitate an understanding of some of the innovative features unique to the disclosed embodiment and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for heat flux bifurcation in porous media.

It is another aspect of the disclosed embodiments to provide for a method and system for analyzing transient thermal response of a packed bed under Local Thermal Non-Equilibrium (LTNE) condition.

It is a further aspect of the disclosed embodiments to provide an exact solution for transient aspects of heat flux bifurcation in a porous media.

The aforementioned aspects and other objectives and advantages can now be achieved as described herein.

The LTNE model is employed to represent the energy transport within a porous medium. Two primary types of heat flux bifurcations in a porous media are investigated for temporal conditions. Heat transfer performances in terms of the fluid, solid, and total Nusselt number are obtained. Qualitative analyses of the effects of thermal conduction at the wall on the total heat exchange between the solid and fluid phases within the heat flux bifurcation region are also performed. Both the transient and diffusion aspects are considered in the solid and fluid phases along with the convection and the fluid-solid interaction. The analytical solution for transient response of a packed bed subject to a constant temperature boundary condition is derived. The heat flux bifurcation phenomenon in a porous media is investigated for temporal conditions, and the analytical two-dimensional thermal behavior and the LTE model is examined under transient conditions. Further, the response time towards steady state conditions is investigated.

### BRIEF DESCRIPTION OF THE FIGURES

The accompanying figures, in which like reference numerals refer to identical or functionally-similar elements throughout the separate views and which are incorporated in and form a part of the specification, further illustrate the disclosed embodiments and, together with the detailed description of the disclosed embodiments, serve to explain the principles of the disclosed embodiments.

FIG. 1 illustrates a schematic diagram of a physical model and the corresponding coordinate system showing a flow through a channel filled with a porous medium, in accordance with the disclosed embodiments;

FIGS. 2A-2F illustrate graphs showing dimensionless temperature distributions for fluid and solid phases for k=0.1, β=0.02, η₁=5, ξ=2, θᵢₙ=−0.4, and for τ=0.2, τ=1.0, τ=2.2, τ=3.0, τ=5.0, and steady state respectively, in accordance with the disclosed embodiments;

FIGS. 3A-3F illustrate graphs showing bifurcation region variations as a function of pertinent parameters β, k, and θᵢₙ, in accordance with the disclosed embodiments;

FIG. 4 illustrates a graph showing dimensionless transverse average temperature distributions for fluid and solid phases for k=0.1, β=0.02, η₁=5, and θᵢₙ=−0.4, in accordance with the disclosed embodiments;

FIG. 5 illustrates a graph showing variations of the transient component of the average temperature for fluid and solid phases for k=0.1, β=0.02, η₁=5, and θᵢₙ=−0.4, in accordance with the disclosed embodiments;

FIG. 6 illustrates a graph showing spatial and temporal variations of the average temperature difference between the solid and fluid phases for k=0.1, β=0.02, η₁=10, and θᵢₙ=−0.4, in accordance with the disclosed embodiments;

FIGS. 7A-7D illustrate graphs showing characteristic time variations of the solid and fluid phases as a function of pertinent parameters k, β, η₁, and θᵢₙ, in accordance with the disclosed embodiments;

FIGS. 8A-8F illustrate graphs showing Nusselt number distributions for fluid and solid phases for k=0.1, β=0.02, η₁=5, and θᵢₙ=−0.4, in accordance with the disclosed embodiments;

FIG. 9 illustrates a graph showing dimensionless total heat flux at the wall for k=0.1, β=0.02, η₁=5, and θᵢₙ=−0.4, in accordance with the disclosed embodiments;

FIGS. 10A-10F illustrate graphs showing an example of the requirement to change the imposed heat flux direction at the wall, due to the bifurcation effect, to obtain a constant temperature condition, in accordance with the disclosed embodiments;

FIGS. 11A-11D illustrate graphs showing heat exchange ratio variations as a function of pertinent parameters η₁, k, θᵢₙ, and β for q_{w}=0, in accordance with the disclosed embodiments;

FIG. 12 illustrates a graph showing heat exchange ratio for k=0.1, β=0.02, η₁=5, θᵢₙ=−0.4, and q_{w}≠0, in accordance with the disclosed embodiments; and

FIG. 13 illustrates a graph showing dimensional characteristic time variations of the solid and fluid phases at different Reₚ's for sandstone, in accordance with the disclosed embodiments.

### DETAILED DESCRIPTION

The particular values and configurations discussed in these non-limiting examples can be varied and are cited merely to illustrate at least one embodiment and are not intended to limit the scope thereof.

The following Table 1 provides the various symbols and meanings used in this section:

TABLE 1
Nomenclature

| | |
|---|---|
| Bi | $Bi = \frac{{h}_{i} α {H}^{2}}{{k}_{s , eff}} , Biot number$ |
| c | specific heat [J kg⁻¹ K⁻¹] |
| dₚ | particle diameter [m] |
| hᵢ | interstitial heat transfer coefficient [W m⁻² K⁻¹] |
| H | half height of the channel [m] |
| I₀ | modified Bessel functions of the first kind of zero order |
| I₁ | modified Bessel functions of the first kind of order 1 |
| k | $\begin{matrix}k = \frac{{k}_{f , eff}}{{k}_{s , eff}} , ratio of the fluid effective thermal \\ conductivity to that of the solid , defined by \\ equation ( 5 f )\end{matrix}$ |
| k_{f} | thermal conductivity of the fluid [W m⁻¹ K⁻¹] |
| k_{f,eff} | effective thermal conductivity of the fluid [W m⁻¹ K⁻¹] |
| kₛ | thermal conductivity of the solid [W m⁻¹ K⁻¹] |
| k_{s,eff} | effective thermal conductivity of the solid [W m⁻¹ K⁻¹] |
| m | Laplace transform parameter |
| Nu | Nusselt number |
| q_{w} | Total heat flux at the wall [W m⁻²] |
| Q(τ) | unit step function defined by equation (18) |
| Qᵢ | integrated internal heat exchange between the solid and |
| | fluid phases [W m⁻²] |
| Qₒ | heat exchange between the solid and fluid phases through |
| | thermal conduction at the wall [W m⁻²] |
| Pr | Prandtl number |
| Reₚ | particle Reynolds number |
| sₙ | ${s}_{n} = \frac{( n + 0.5 ) π}{{η}_{1}}$ |
| t | time [s] |
| T | temperature [K] |
| T₀ | initial temperature [K] |
| u | fluid velocity [m s⁻¹] |
| U | function of ξ and τ, defined by equations (6) and (7) |
| V | function of η, defined by equation s (6) and (7) |
| W | Laplace transformation of U |
| x | longitudinal coordinate [m] |
| y | transverse coordinate [m] |

Greek symbols

| | |
|---|---|
| α | interfacial area per unit volume of the porous medium [m⁻¹] |
| ε | porosity |
| β | $β = \frac{{ɛρ}_{f} {c}_{f}}{( 1 - ɛ ) {ρ}_{s} {c}_{s}} , parameter defined by equation ( 5 e )$ |
| η | non-dimensional transverse coordinate, defined by equation (5c) |
| η₁ | $\begin{matrix}{η}_{1} = \frac{H}{\sqrt{{k}_{s , eff} / ( {h}_{i} α )}} , non \text{-} dimensional half height of \\ the channel , defined by equation ( 5 d )\end{matrix}$ |
| ξ | $\begin{matrix}ξ = \frac{{xh}_{i} α}{{ρ}_{f} {c}_{f} u} , non \text{-} dimensional axial length scale , \\ defined by equation ( 5 a )\end{matrix}$ |
| θ | $\begin{matrix}θ = \frac{T - {T}_{w}}{{T}_{0} - {T}_{w}} , non \text{-} dimensional temperature , defined \\ by equation ( 5 g )\end{matrix}$ |
| μ | dynamic viscosity [kg m⁻¹ s⁻¹] |
| ρ | density [kg m⁻³] |
| γ | heat exchange ratio, defined by equation (49) |
| Ω_{w} | dimensionless total heat flux at the wall, defined by equation (46) |
| τ | $\begin{matrix}τ = \frac{{h}_{i} α t}{( 1 - ɛ ) {ρ}_{s} {c}_{s}} , non \text{-} dimensional time , defined by \\ equation ( 5 b )\end{matrix}$ |
| τ_{f} | non-dimensional characteristic time for fluid phase |
| τₛ | non-dimensional characteristic time for solid phase |

Subscripts

| | |
|---|---|
| d | fully developed |
| f | fluid phase |
| in | inlet |
| NC | without convection term in the fluid phase |
| s | solid phase, steady state |
| t | total |
| w | wall |
| o | initial |

Superscripts

| | |
|---|---|
| a | transverse average |

The LTNE model can be employed to represent the energy transport within a porous medium. Two primary types of heat flux bifurcations in a porous media are investigated for temporal conditions. Heat transfer performances in terms of the fluid, solid, and total Nusselt number are presented. Qualitative analyses of the effects of thermal conduction at the wall on the total heat exchange between the solid and fluid phases within the heat flux bifurcation region are also performed. Both the transient and diffusion aspects are considered in the solid and fluid phases along with the convection and the fluid-solid interaction. The analytical solution for transient response of a packed bed subject to a constant temperature boundary condition can be derived. The heat flux bifurcation phenomenon in a porous media is investigated for temporal conditions, and the analytical two-dimensional thermal behavior and the LTE model is examined under transient conditions. Further, the response time towards steady state conditions can be investigated.

### 1. MODELING AND FORMULATION

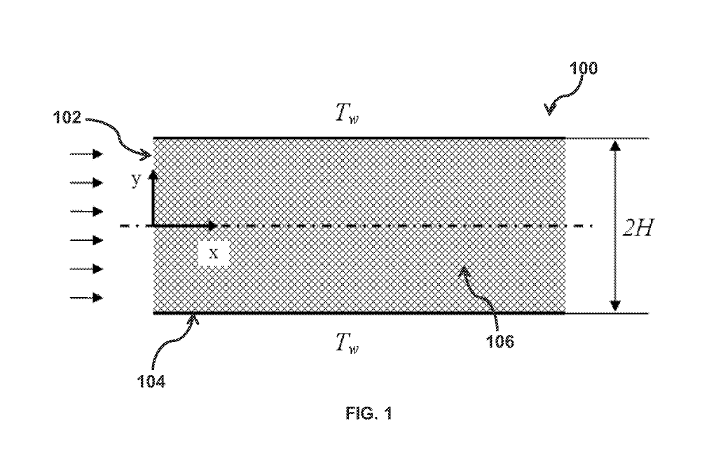

FIG. 1 illustrates a schematic diagram of a physical model and the corresponding coordinate system 100. Fluid 102 flows through a rectangular channel 104 filled with a porous medium 106 subject to a constant temperature boundary condition. The height of the channel 104 is 2H and the temperature at the wall is T_{w}. The following assumptions are invoked in the analyzing this problem. The flow is incompressible and represented by the Darcian flow model and natural convection and radiative heat transfer are negligible. Also, axial heat conduction in both the solid and fluid phases is negligible and properties such as specific heat, density, and thermal conductivity, as well as porosity, are assumed to be constant.

### 1.1 Governing Equation and Boundary and Initial Conditions

Based on these assumptions, the following governing equations are obtained from the work of Amiri, A., Vafai, K., 1998, “Transient analysis of incompressible flow through a packed bed,” Int. J. Heat Mass Transfer, 41, pp. 4259-4279 employing the local thermal non-equilibrium model.

### Fluid Phase

$$β \frac{\partial {θ}_{f}}{\partial τ} + \frac{\partial {θ}_{f}}{\partial ξ} = k \frac{{\partial }^{2} {θ}_{f}}{\partial {η}^{2}} + ( {θ}_{s} - {θ}_{f} ) \qquad Eq . ( 1 )$$

### Solid Phase

$$\frac{\partial {θ}_{s}}{\partial τ} = \frac{{\partial }^{2} {θ}_{s}}{\partial {η}^{2}} - ( {θ}_{s} - {θ}_{f} ) \qquad Eq . ( 2 )$$

### Boundary Conditions

$$\begin{matrix}{{{θ}_{f} \vert}_{η = {η}_{1}} = {θ}_{s} \vert}_{η = {η}_{1}} = 0 & Eq . ( 3 a ) \\ {{\frac{\partial θ}{\partial η} \vert}_{η = 0} = \frac{\partial {θ}_{s}}{\partial η} \vert}_{η = 0} = 0 & Eq . ( 3 b ) \\ {{θ}_{f} \vert}_{ξ = 0} = {θ}_{i n} & Eq . ( 3 c )\end{matrix}$$

### Initial Conditions

θ_{f}|_{τ=0}=θₛ|_{τ=0}=1 Eq. (4)

where

$$\begin{matrix}ξ = \frac{{xh}_{i} α}{{ρ}_{f} {c}_{f} u} & Eq . ( 5 a ) \\ τ = \frac{t}{( 1 - ɛ ) {ρ}_{s} {c}_{s} / ( {h}_{i} α )} & Eq . ( 5 b ) \\ η = \frac{y}{\sqrt{{k}_{s , eff} / ( {h}_{i} α )}} & Eq . ( 5 c ) \\ {η}_{1} = \frac{H}{\sqrt{{k}_{s , eff} / ( {h}_{i} α )}} = \sqrt{Bi} where \\ Bi = \frac{{h}_{i} α {H}^{2}}{{k}_{s , eff}} & Eq . ( 5 d ) \\ β = \frac{ɛ {ρ}_{f} {c}_{f}}{( 1 - ɛ ) {ρ}_{s} {c}_{s}} & Eq . ( 5 e ) \\ k = \frac{{k}_{f , eff}}{{k}_{s , eff}} & Eq . ( 5 f ) \\ θ = \frac{T - {T}_{w}}{{T}_{0} - {T}_{w}} & Eq . ( 5 g )\end{matrix}$$

### 1.2 Solution Methodology

The non-dimensional fluid and solid temperature distributions θ_{f}(ξ,η,τ) and θₛ(ξ,η,τ) are represented as

θ_{f}(ξ,η,τ)=U_{f}(ξ,τ)V(η) Eq. (6)

θₛ(ξ,η,τ)=Uₛ(ξ,τ)V(η) Eq. (7)

Substituting equations (6) and (7) into equations (1) and (2) along with the boundary conditions and applying the separation of variables and Laplace transformation yields:

$$\begin{matrix} {θ}_{f} ( ξ , η , τ ) = {\sum }_{n = 0}^{∞} {U}_{fn} ( ξ , τ ) cos ( {s}_{n} η ) & Eq . ( 8 ) \\ {θ}_{s} ( ξ , η , τ ) = {\sum }_{n = 0}^{∞} {U}_{sn} ( ξ , τ ) cos ( {s}_{n} η ) \\ where & Eq . ( 9 ) \\ {s}_{n} = \frac{( n + 0.5 ) π}{{η}_{1}} \\ n = 0 , 1 , 2 , … & Eq . ( 10 ) \\ β m {W}_{fn} - β \frac{2 sin ( {s}_{n} {η}_{1} )}{{s}_{n} {η}_{1}} + \frac{\partial {W}_{fn}}{\partial ξ} - ( {W}_{sn} - {W}_{fn} ) = - {s}_{n}^{2} k {W}_{fn} & Eq . ( 11 ) \\ m {W}_{sn} - \frac{2 sin ( {s}_{n} {η}_{1} )}{{s}_{n} {η}_{1}} + ( {W}_{sn} - {W}_{fn} ) = - {s}_{n}^{2} {W}_{sn} & Eq . ( 12 )\end{matrix}$$

wherein Wₛₙ and W_{fn} are the Laplace transformation of Uₛₙ and U_{fn}, respectively, given by:

Wₛₙ=∫₀^{∞}Uₛₙe^{-mτ}dτ (13)

W_{fn}=∫₀^{∞}U_{fn}e^{-mτ}dτ Eq. (14)

Solving equations (11) and (12) yields

$${W}_{fn} = [ \frac{{θ}_{i n}}{m} - \frac{β ( 1 + m + {s}_{n}^{2} ) + 1}{( β m + {s}_{n}^{2} k + 1 ) ( 1 + m + {s}_{n}^{2} )} ] \frac{2 sin ( {s}_{n} {η}_{1} )}{{s}_{n} {η}_{1}} exp [ - ( β m + {s}_{n}^{2} k + 1 - \frac{1}{1 + m + {s}_{n}^{2}} ) ξ ] + \frac{β ( 1 + m + {s}_{n}^{2} ) + 1}{( β m + {s}_{n}^{2} k + 1 ) ( 1 + m + {s}_{n}^{2} ) - 1} \frac{2 sin ( {s}_{n} {η}_{1} )}{{s}_{n} {η}_{1}} \qquad Eq . ( 15 )$$

By utilizing inverse Laplace transform, Uₛₙ and U_{fn} are obtained as:

$$\begin{matrix} {U}_{sn} = ( {θ}_{s 1} + {θ}_{s 2} + {θ}_{s 3} + {θ}_{s 4} + {θ}_{s 5} + {θ}_{s 6} ) \frac{2 sin ( {s}_{n} {η}_{1} )}{{s}_{n} {η}_{1}} & Eq . ( 16 ) \\ {U}_{fn} = ( {θ}_{f 1} + {θ}_{f 2} + {θ}_{f 3} + {θ}_{f 4} + {θ}_{f 5} ) \frac{2 sin ( {s}_{n} {η}_{1} )}{{s}_{n} {η}_{1}} \\ where \\ {θ}_{s 1} = {θ}_{i n} f ( {p}_{0} ) \\ {θ}_{s 2} = - ( \frac{{p}_{1}}{{p}_{1} - {p}_{2}} + \frac{β {s}_{n}^{2} + β + 1}{β ( {p}_{1} - {p}_{2} )} ) f ( {p}_{1} ) \\ {θ}_{s 3} = - ( \frac{{p}_{2}}{{p}_{2} - {p}_{1}} + \frac{β {s}_{n}^{2} + β + 1}{β ( {p}_{2} - {p}_{1} )} ) f ( {p}_{2} ) \\ {θ}_{s 4} = [ \frac{1}{{p}_{1} - {p}_{2}} + \frac{1}{β ( {p}_{1} - {p}_{2} ) ( {p}_{1} + {s}_{n}^{2} + 1 )} ] exp ( {p}_{1} τ ) \\ {θ}_{s 5} = [ \frac{1}{{p}_{2} - {p}_{1}} + \frac{1}{β ( {p}_{2} - {p}_{1} ) ( {p}_{2} + {s}_{n}^{2} + 1 )} ] exp ( {p}_{2} τ ) \\ {θ}_{f 1} = {θ}_{i n} g ( {p}_{0} ) \\ {θ}_{f 2} = - ( \frac{{p}_{1}}{{p}_{1} - {p}_{2}} + \frac{β {s}_{n}^{2} + β + 1}{β ( {p}_{1} - {p}_{2} )} ) g ( {p}_{1} ) \\ {θ}_{f 3} = - ( \frac{{p}_{2}}{{p}_{2} - {p}_{1}} + \frac{β {s}_{n}^{2} + β + 1 }{β ( {p}_{2} - {p}_{1} )} ) g ( {p}_{2} ) \\ {θ}_{f 4} = [ \frac{{p}_{1}}{{p}_{1} - {p}_{2}} + \frac{β {s}_{n}^{2} + β + 1}{β ( {p}_{1} - {p}_{2} )} ] exp ( {p}_{1} τ ) \\ {θ}_{f 5} = [ \frac{{p}_{2}}{{p}_{2} - {p}_{1}} + \frac{β {s}_{n}^{2} + β + 1}{β ( {p}_{2} - {p}_{1} )} ] exp ( {p}_{2} τ ) \\ f ( p ) = exp [ - ( {ks}_{n}^{2} + 1 ) ξ + p ( τ - β ξ ) ] {\int }_{0}^{τ} {I}_{0} ( 2 \sqrt{ξ {t}_{1}} ) exp [ - ( {s}_{n}^{2} + 1 + p ) {t}_{1} ] Q ( τ - {t}_{1} - β ξ ) d {t}_{1} \\ g ( p ) = exp [ - ( {ks}_{n}^{2} + 1 ) ξ + p ( τ - β ξ ) ] {\int }_{0}^{τ} \sqrt{\frac{ξ}{τ}} {I}_{1} ( 2 \sqrt{ξ {t}_{1}} ) exp [ - ( {s}_{n}^{2} + 1 + p ) {t}_{1} ] Q ( τ - {t}_{1} - β ξ ) d {t}_{1} + exp [ - ( {ks}_{n}^{2} + 1 ) ξ + p ( τ - β ξ ) ] Q ( τ - β ξ ) & Eq . ( 17 )\end{matrix}$$

where Q(τ) is the unit step function,

$$Q ( τ ) = \{ \begin{matrix}1 & τ > 0 \\ 1 & τ < 0\end{matrix} \\ and \\ {p}_{0} = 0 \\ {p}_{1} = \frac{\begin{matrix}- ( β {s}_{n}^{2} + β + {ks}_{n}^{2} + 1 ) + \\ \sqrt{{( β {s}_{n}^{2} + β - {ks}_{n}^{2} - 1 )}^{2} + 4 β}\end{matrix}}{2 β} \\ {p}_{2} = \frac{\begin{matrix}- ( β {s}_{n}^{2} + β + {ks}_{n}^{2} + 1 ) - \\ \sqrt{{( β {s}_{n}^{2} + β - {ks}_{n}^{2} - 1 )}^{2} + 4 β}\end{matrix}}{2 β} \qquad Eq . ( 18 )$$

By substituting Eqs. (16) and (17) in Eqs. (8) and (9), the final resulting solutions for equations (1)-(4) are obtained as:

$$\begin{matrix}{θ}_{s} = \frac{2}{{η}_{1}} {\sum }_{n = 0}^{∞} ( {θ}_{s 1} + {θ}_{s 2} + {θ}_{s 3} + {θ}_{s 4} + {θ}_{s 5} + {θ}_{s 6} ) \frac{sin ( {s}_{n} {η}_{1} )}{{s}_{n}} cos ( {s}_{n} η ) & Eq . ( 19 ) \\ {θ}_{f} = \frac{2}{{η}_{1}} {\sum }_{n = 0}^{∞} ( {θ}_{f 1} + {θ}_{f 2} + {θ}_{f 3} + {θ}_{f 4} + {θ}_{f 5} ) \frac{sin ( {s}_{n} {η}_{1} )}{{s}_{n}} cos ( {s}_{n} η ) & Eq . ( 20 )\end{matrix}$$

The average temperature can be calculated from:

$$\begin{matrix}{θ}_{s}^{a} = \frac{1}{{η}_{1}} {\int }_{0}^{{η}_{1}} {θ}_{s} d η & Eq . ( 21 ) \\ {θ}_{f}^{a} = \frac{1}{{η}_{1}} {\int }_{0}^{{η}_{1}} {θ}_{f} d η & Eq . ( 22 )\end{matrix}$$

Substituting equations (19) and (20) into equations (21) and (22) yields:

$$\begin{matrix}{θ}_{s}^{a} = \frac{2}{{η}_{1}^{2}} {\sum }_{n = 0}^{∞} ( {θ}_{s 1} + {θ}_{s 2} + {θ}_{s 3} + {θ}_{s 4} + {θ}_{s 5} + {θ}_{s 6} ) \frac{1}{{s}_{n}^{2}} & Eq . ( 23 ) \\ {θ}_{f}^{n} = \frac{2}{{η}_{1}^{2}} {\sum }_{n = 0}^{∞} ( {θ}_{f 1} + {θ}_{f 2} + {θ}_{f 3} + {θ}_{f 4} + {θ}_{f 5} ) \frac{1}{{s}_{n}^{2}} & Eq . ( 24 )\end{matrix}$$

### 1.3 Steady State Solution

The governing equations for steady state conditions can be obtained from equations (1) and (2) by deleting the transient term. This results in:

$$\begin{matrix}{θ}_{ss} = \frac{2 {θ}_{i n}}{{η}_{1}} {\sum }_{n = 0}^{∞} exp [ - ( {ks}_{n}^{2} + 1 - \frac{1}{{s}_{n}^{2} + 1} ) ξ ] \frac{sin ( {s}_{n} {η}_{1} )}{{s}_{n} ( {s}_{n}^{2} + 1 )} cos ( {s}_{n} η ) & Eq . ( 25 ) \\ {θ}_{fs} = \frac{2 {θ}_{i n}}{{η}_{1}} {\sum }_{n = 0}^{∞} exp [ - ( {ks}_{n}^{2} + 1 - \frac{1}{{s}_{n}^{2} + 1} ) ξ ] \frac{sin ( {s}_{n} {η}_{1} )}{{s}_{n}} cos ( {s}_{n} η ) & Eq . ( 26 )\end{matrix}$$

and the average temperature under steady state conditions are obtained as:

$$\begin{matrix}{θ}_{ss}^{a} = \frac{2 {θ}_{i n}}{{η}_{1}^{2} } {\sum }_{n = 0}^{∞} exp [ - ( {ks}_{n}^{2} + 1 - \frac{1}{{s}_{n}^{2} + 1} ) ξ ] \frac{1}{{s}_{n}^{2} ( {s}_{n}^{2} + 1 )} & Eq . ( 27 ) \\ {θ}_{fs}^{a} = \frac{2 {θ}_{i n}}{{η}_{1}^{2}} {\sum }_{n = 0}^{∞} exp [ - ( {ks}_{n}^{2} + 1 - \frac{1}{{s}_{n}^{2} + 1} ) ξ ] \frac{1}{{s}_{n}^{2}} & Eq . ( 28 )\end{matrix}$$

1.4 Solution for the Case without the Convective Term in the Fluid Phase

The governing equations for the case without the convective contribution in the fluid phase can be obtained from equations (1) and (2). This results in:

$$\begin{matrix}{θ}_{sNC} = \frac{2}{{η}_{1}} {\sum }_{n = 0}^{∞} ( {θ}_{s 4} + {θ}_{s 5} + {θ}_{s 6} ) \frac{sin ( {s}_{n} {η}_{1} )}{{s}_{n}} cos ( {s}_{n} η ) & Eq . ( 29 ) \\ {θ}_{fNC} = \frac{2}{{η}_{1}} {\sum }_{n = 0}^{∞} ( {θ}_{f 4} + {θ}_{f 5} ) \frac{sin ( {s}_{n} {η}_{1} )}{{s}_{n}} cos ( {s}_{n} η ) & Eq . ( 30 )\end{matrix}$$

The average temperatures for the case without the convective contribution in the fluid phase are obtained as:

$$\begin{matrix}{θ}_{sNC}^{a} = \frac{2}{{η}_{1}^{2}} {\sum }_{n = 0}^{∞} ( {θ}_{s 4} + {θ}_{s 5} + {θ}_{s 6} ) \frac{1}{{s}_{n}^{2}} & Eq . ( 31 ) \\ {θ}_{fNC}^{a} = \frac{2}{{η}_{1}^{2} } {\sum }_{n = 0}^{∞} ( {θ}_{f 4} + {θ}_{f 5} ) \frac{1}{{s}_{n}^{2}} & Eq . ( 32 )\end{matrix}$$

### 2. RESULTS AND DISCUSSION

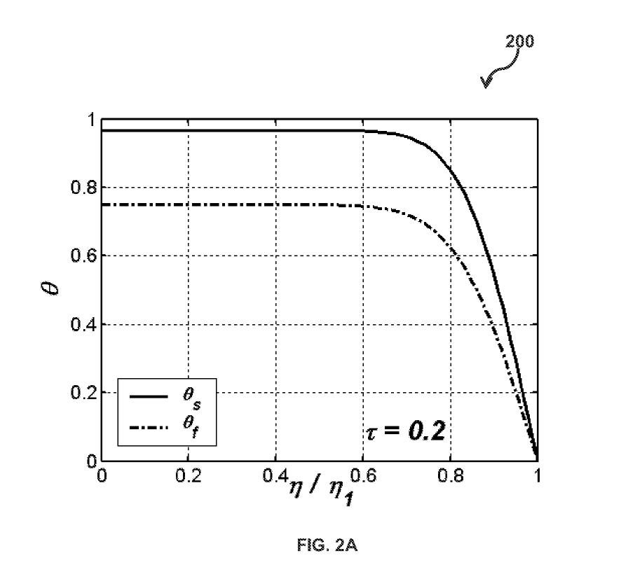

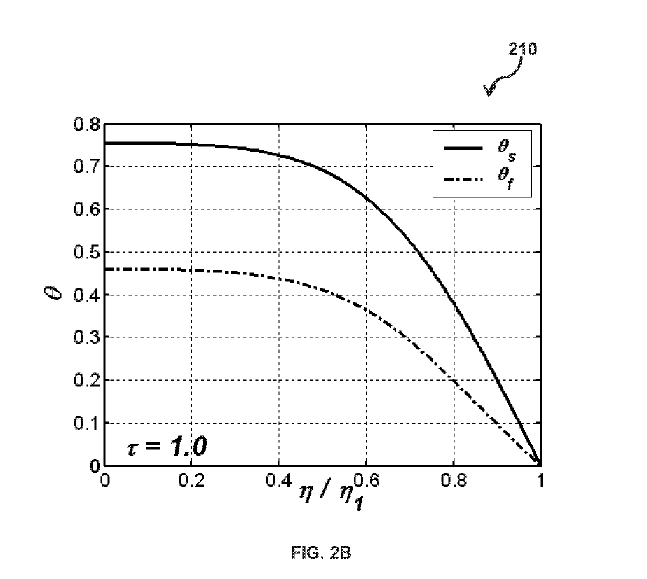

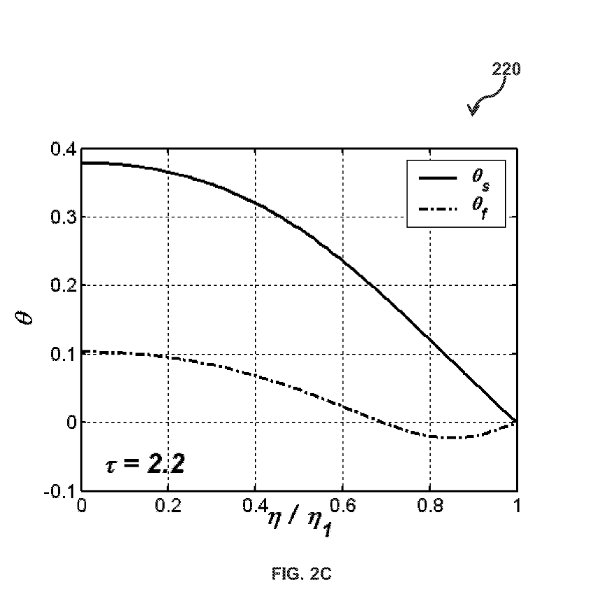

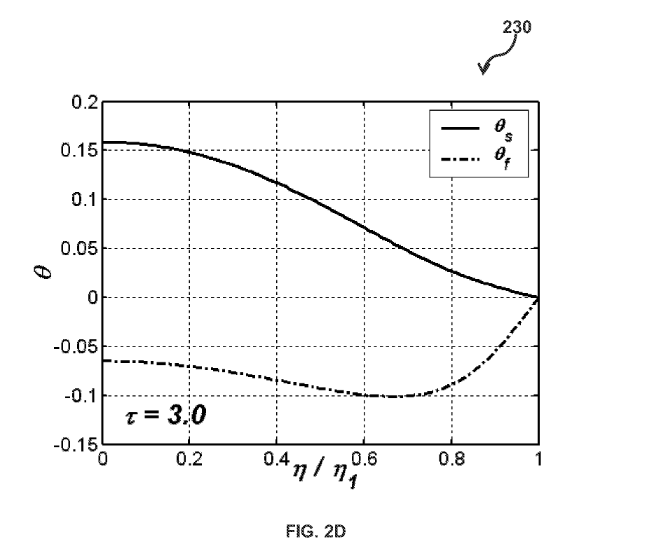

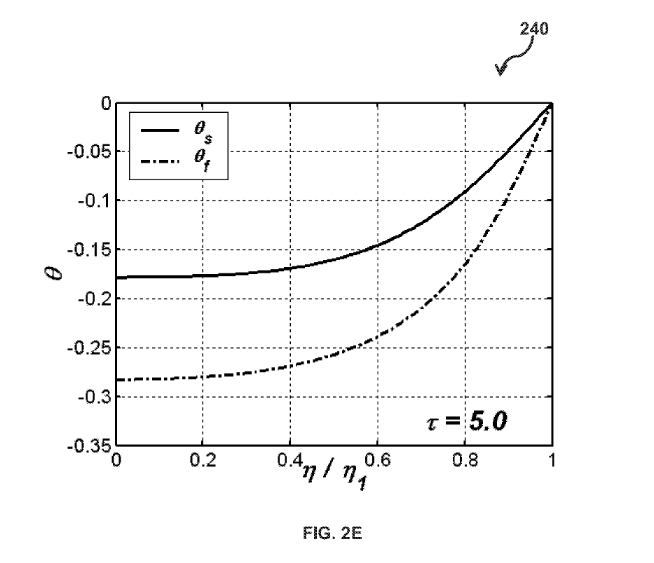

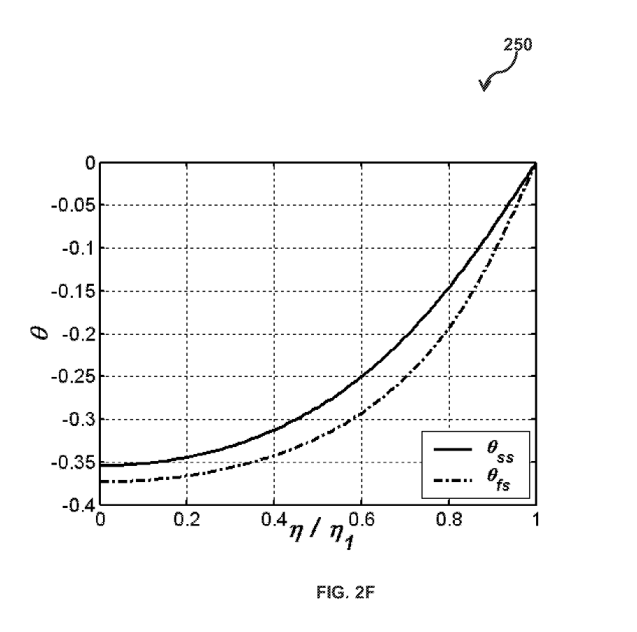

The dimensionless temperature distributions for the fluid and solid phases are shown in the FIG. 2. When τ is small, the temperature distribution is mainly dependent on the initial condition. However, when τ is large enough, the temperature distribution is primarily dependent on the inlet condition. Although the temperature difference between the fluid and solid phases is relatively small when steady state conditions are reached, it is relatively large compared to the fluid and solid temperatures during the transient process. These results show that the LTE model might be unsuitable to describe the transient heat transfer process in a porous media. This figure also discloses that the thermal boundary layer grows as τ increases, which indicates a substantial two-dimensional thermal characteristic.

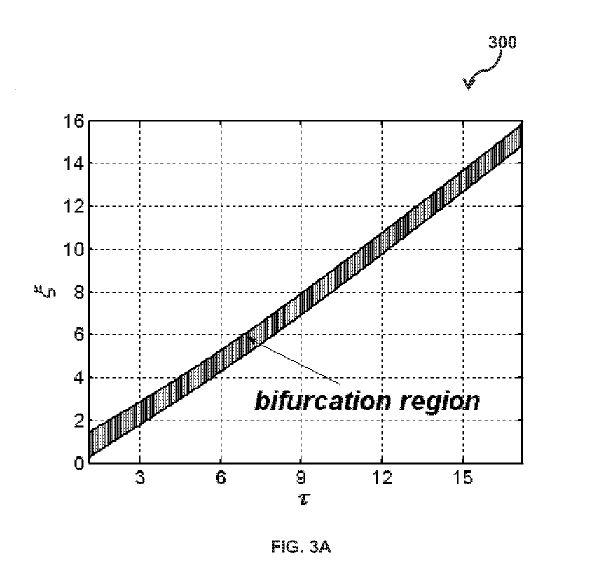

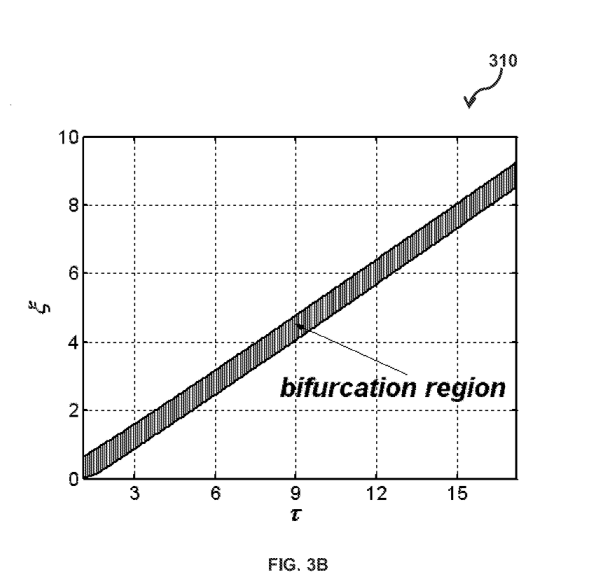

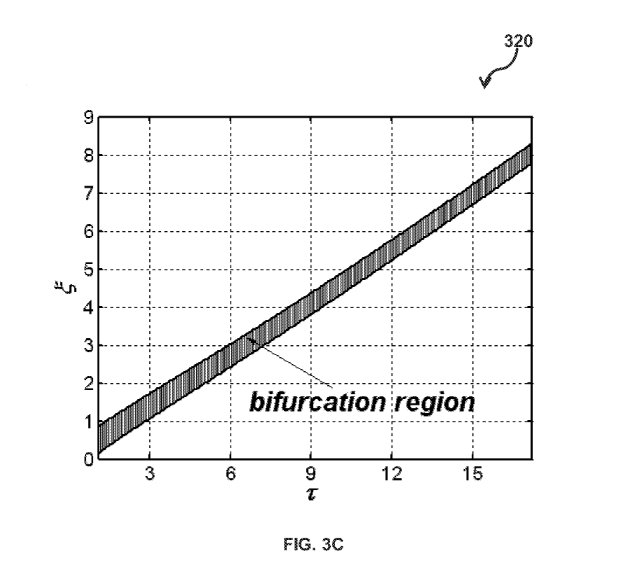

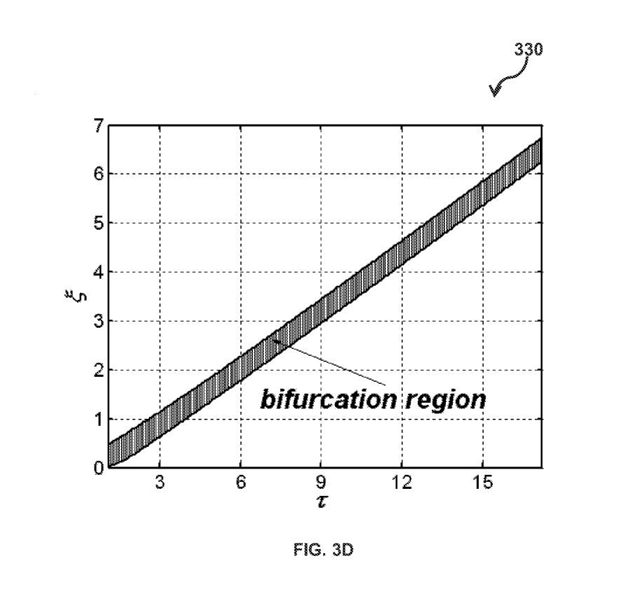

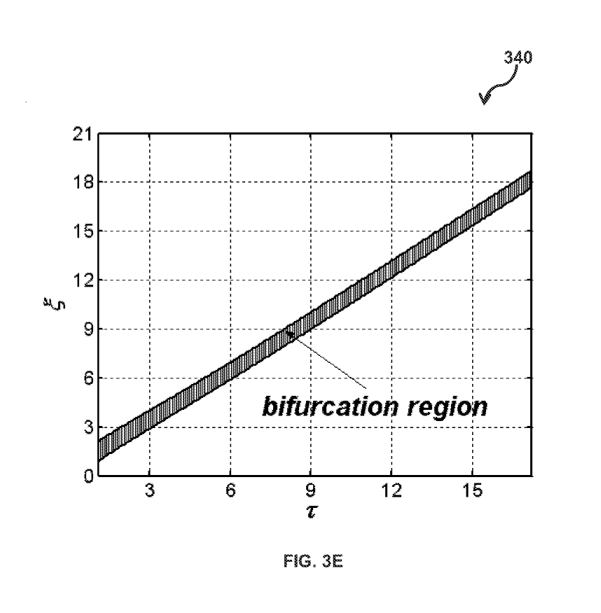

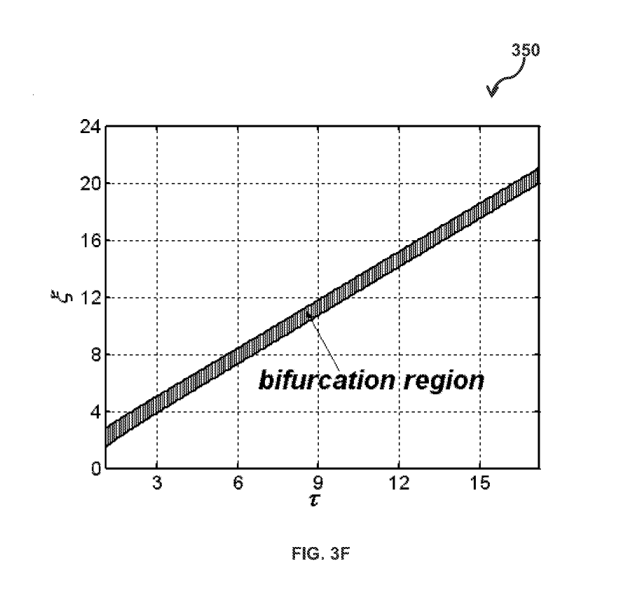

It is important to note that the direction of the temperature gradient for the fluid and solid phases are different at the wall (η=η₁) in FIGS. 2(c,d). This leads to a heat flux bifurcation around these times. The concept of temperature gradient bifurcation in the presence of internal heat generation in both the fluid and solid phases has been established in detail for the first time by Yang, K., Vafai, K., 2010, “Analysis of temperature gradient bifurcation in porous media—an exact solution,” Int. J. Heat Mass Transfer, 53, pp. 4316-4325. Utilizing the analytical solutions given in Eqs. (19) and (20), the region over which heat flux bifurcation phenomenon occurs is established and illustrated in FIG. 3. It is found that this phenomenon occurs only over a given axial region at a given time frame.

The bifurcation region moves downstream as τ increases and is dependent on the pertinent parameters k, β, and θᵢₙ. When k, β, and θᵢₙ decrease, the bifurcation region moves forward at a faster rate. Note that the bifurcation phenomenon only occurs during the transient period. Bifurcation phenomenon disappears when steady state conditions are reached. Note that the bifurcation aspects related to phase change as analyzed in Vafai K., Tien, H. C., 1989, “A Numerical Investigation of Phase Change Effects in Porous Materials,” Int. J. Heat Mass Transfer,” 32, pp. 1261-1277, have not been investigated in this work.

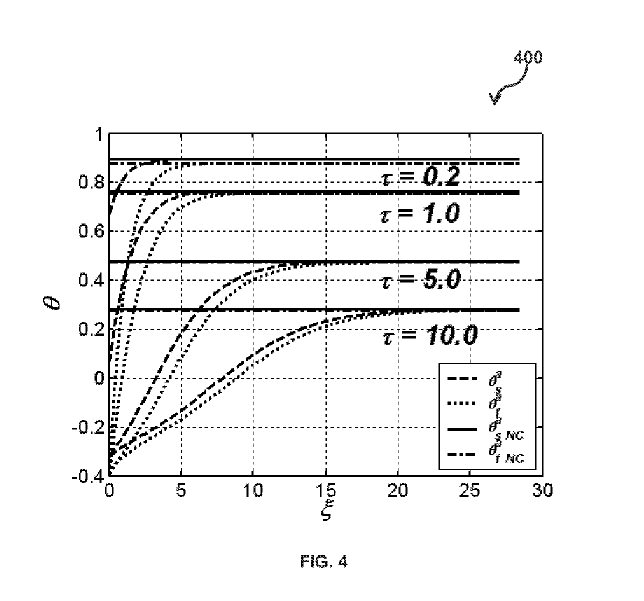

The dimensionless transverse average temperature distributions for fluid and solid phases for k=0.1, β=0.02, η₁=5, and θᵢₙ=−0.4 are shown in FIG. 4. It is found that the transverse average temperatures approach the case with no convection in the fluid phase when the axial length is large enough. Based on Eqs. (19), (20), (29), and (30), if ξ satisfies the condition,

$$ξ > \frac{τ}{β} \qquad Eq . ( 33 )$$

convection will have an insignificant impact on the temperature distributions for fluid and solid phases. This is because the inlet condition effects do not propagate far enough to influence that time level.

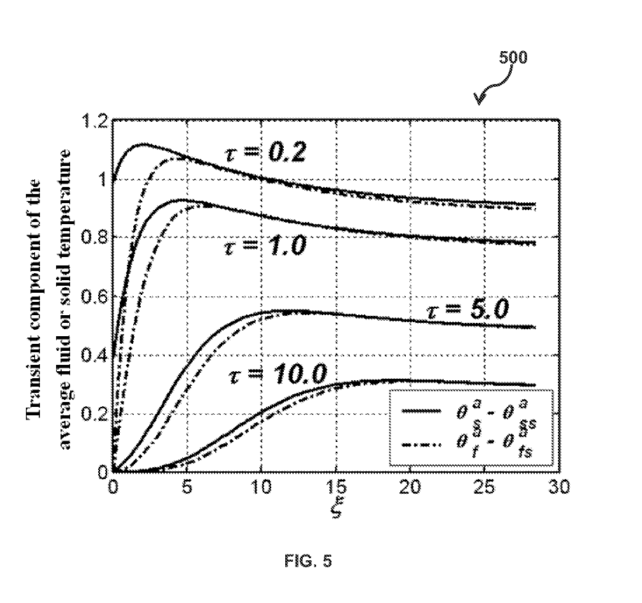

The difference between θₛ^{a} and θₛₛ^{a} presents the transient component of the average solid temperature θₛ^{a}, and the difference between θ_{f}^{a} and θ_{fs}^{a} presents the transient component of the average fluid temperature θ_{f}^{a}. These differences are shown in FIG. 5 for k=0.1, β=0.02, η₁=5, and θᵢₙ=−0.4. It is found that the peak positions for the transient components of the solid and fluid phases moves downstream with time, while the magnitude of the peak decreases with time.

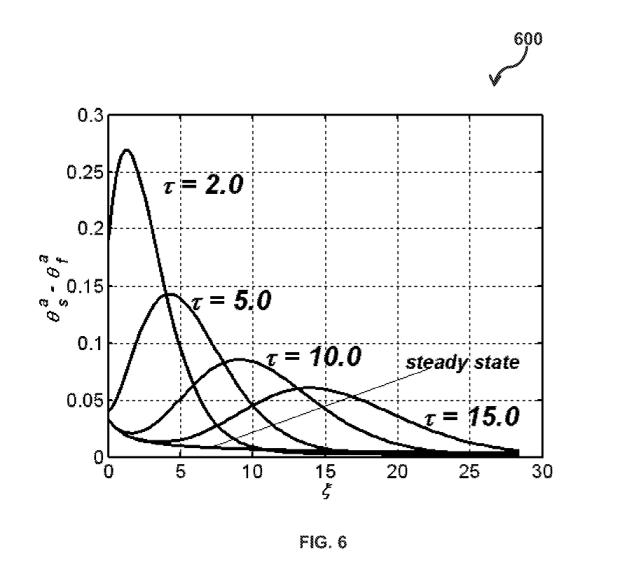

The transverse average temperature difference distributions between the solid and fluid phases for k=0.1, β=0.02, η₁=5, and θᵢₙ=−0.4 is shown in FIG. 6. It is found that there is a peak for the temperature difference at a given τ and that the peak moves downstream as time progresses. For unsteady flow of a gas through a porous medium, Vafai, K., Sozen, M., 1990, “Analysis of energy and momentum transport for fluid flow through a porous bed,” ASME Journal of Heat Transfer, 112, pp. 690-699, utilized the maximum difference between the solid and fluid phase temperatures to establish the validity of local thermal equilibrium assumption. It was found that the local thermal equilibrium assumption becomes more viable as both the Darcy and particle Reynolds numbers decrease. They had shown that a decrease in the Darcy number translates into a decrease in the particle diameter, which results in an increase in the specific surface area (α), thus increasing the fluid-to-solid heat transfer interaction by offering a larger surface area. Further, as the fluid velocity increases the time for the solid-to-fluid heat exchange interaction decreases, resulting in a decrease in the efficiency of heat exchange between the solid and fluid phases, thus increasing the deviation from the local thermal equilibrium. Similarly, here based on the definition of ξ given in Eq. (5a), an increase in the specific surface area (α) and a decrease in the fluid velocity can be translated into an increase in ξ. As such the temperature difference between the solid and fluid phases becomes smaller at larger value of ξ, as can be seen in FIG. 6.

The time τₛ or τ_{f} that it takes for either the solid or fluid phase to reach steady state condition is based on when the quantities defined by:

$$\begin{matrix}\vert \frac{{θ}_{s}^{a} ( ξ , {τ}_{s} ) - {θ}_{ss}^{a} ( ξ )}{{θ}_{ss}^{a} ( ξ )} \vert = 0.01 & Eq . ( 34 a ) \\ \vert \frac{{θ}_{f}^{a} ( ξ , {τ}_{f} ) - {θ}_{fs}^{a} ( ξ )}{{θ}_{fs}^{a} ( ξ )} \vert = 0.01 & Eq . ( 34 b )\end{matrix}$$

are achieved respectively.

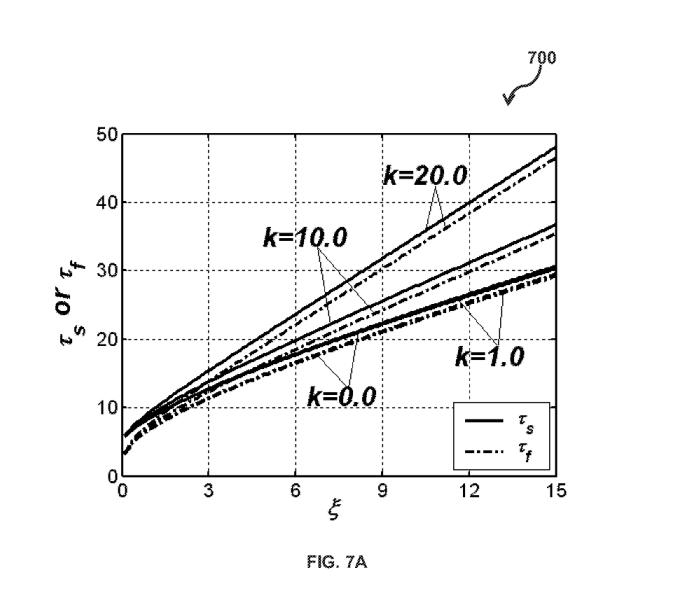

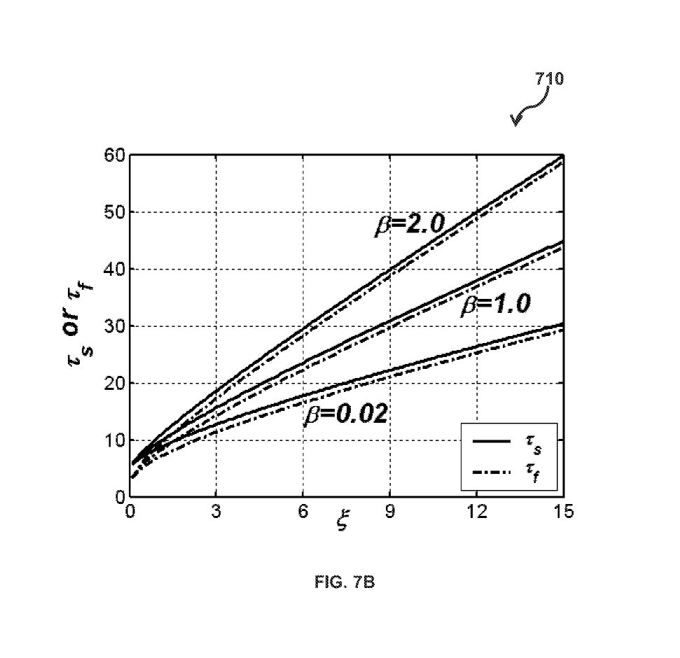

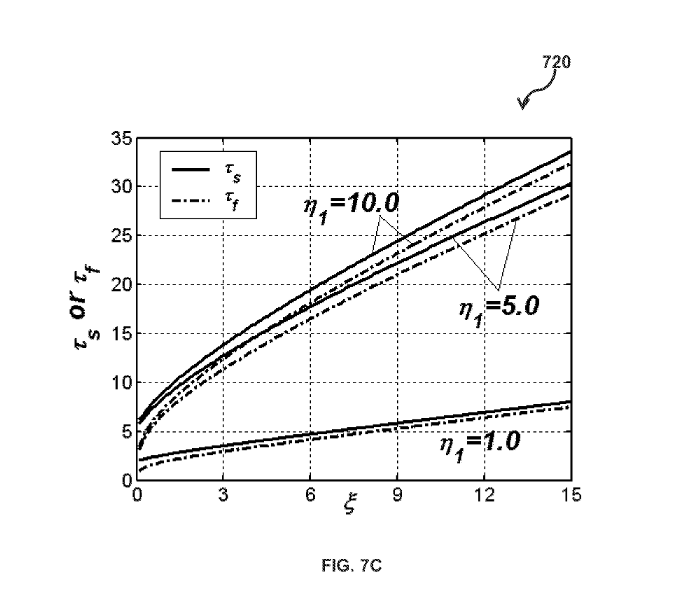

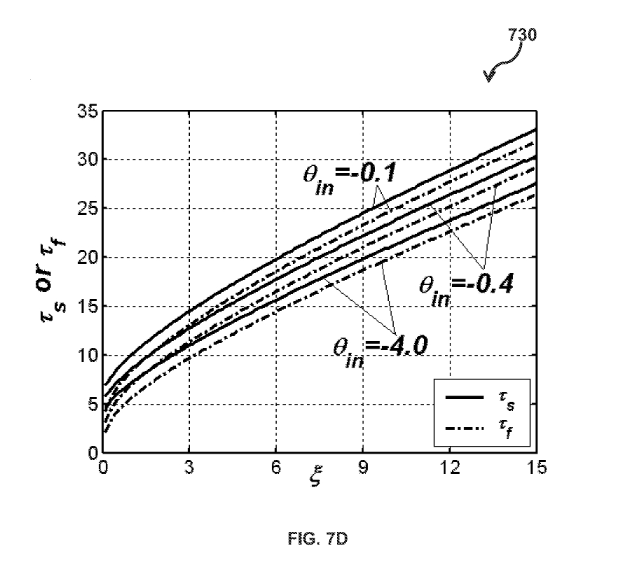

The characteristic times for solid and fluid phases to reach steady state are shown in FIG. 7. As can be seen, the characteristic time for the solid is always larger than that for the fluid phase. It can also be seen that the characteristic times increase as k, β, η₁ or θᵢₙ increase. It is found that the characteristic times remain almost unchanged with k at any given ξ when k<1. This is due to the negligible influence of the fluid thermal conduction.

### 4. NUSSELT NUMBER RESULTS

The Nusselt numbers for fluid and solid phases can be presented as:

$$\begin{matrix}{Nu}_{f} = - \frac{4 {η}_{1}}{{θ}_{f}^{a}} {( \frac{\partial {θ}_{f}}{\partial η} )}_{η = {η}_{1}} & Eq . ( 35 ) \\ {Nu}_{s} = - \frac{4 {η}_{1}}{{θ}_{f}^{a} k} {( \frac{\partial {θ}_{s}}{\partial η} )}_{η = {η}_{1}} & Eq . ( 36 )\end{matrix}$$

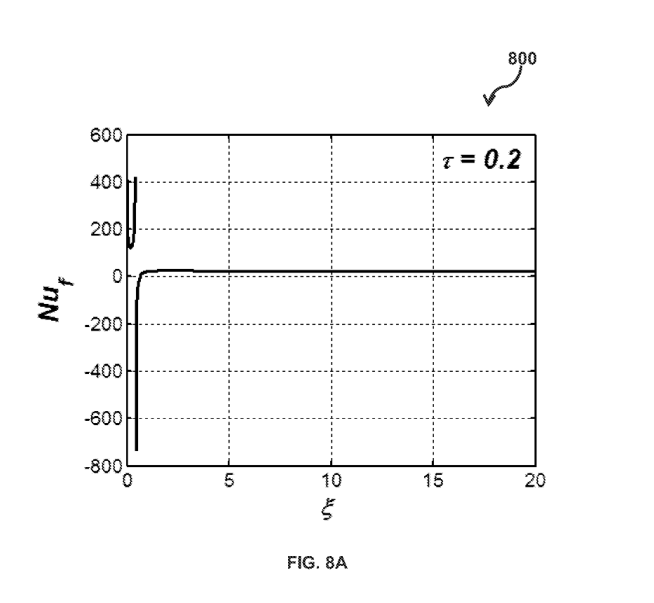

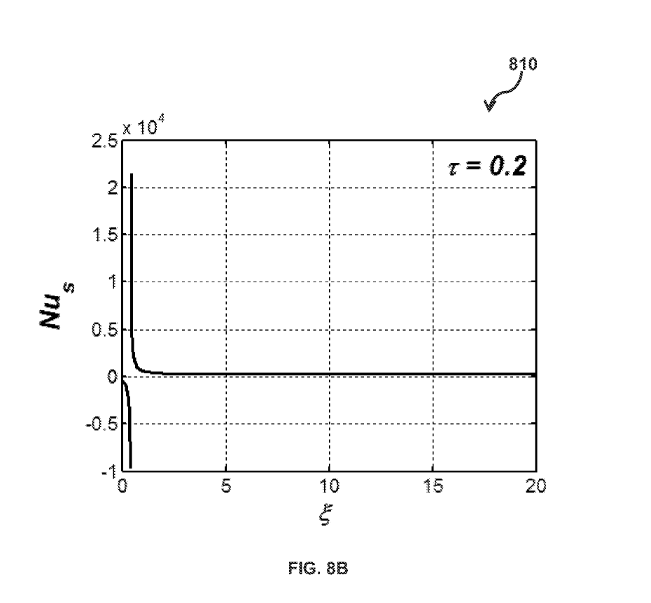

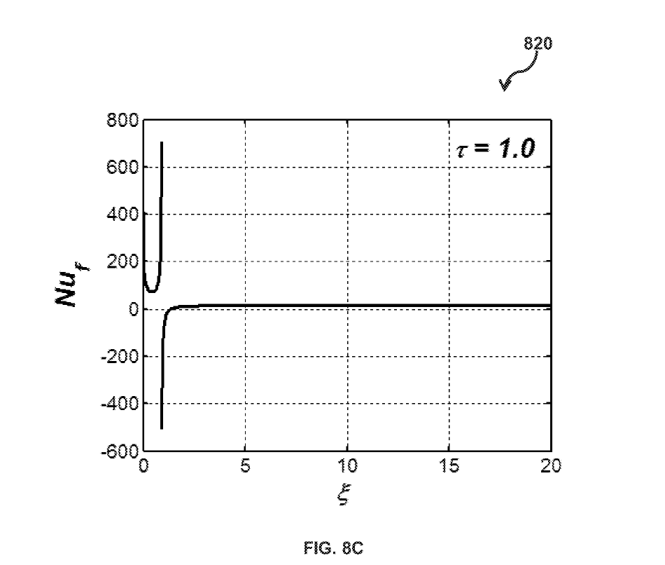

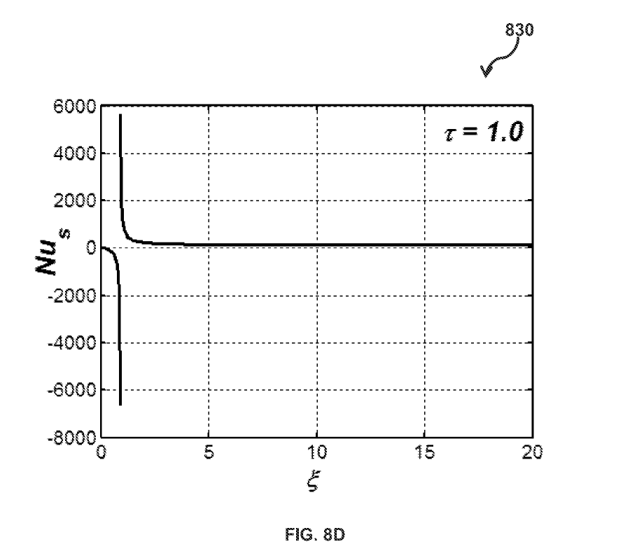

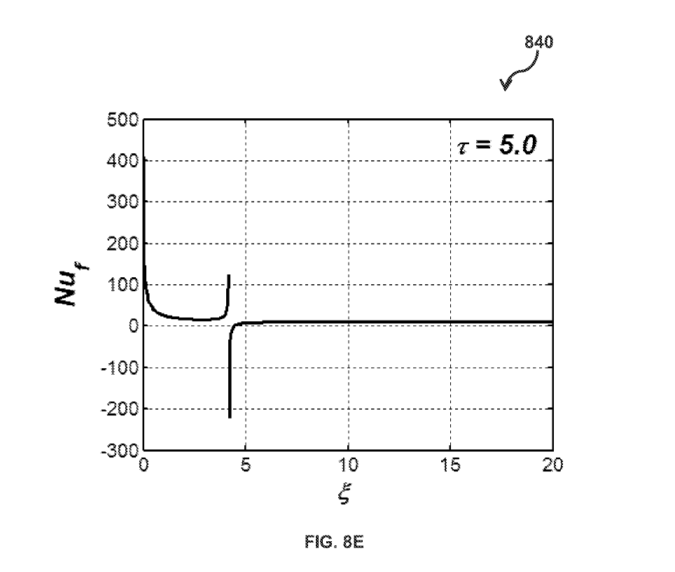

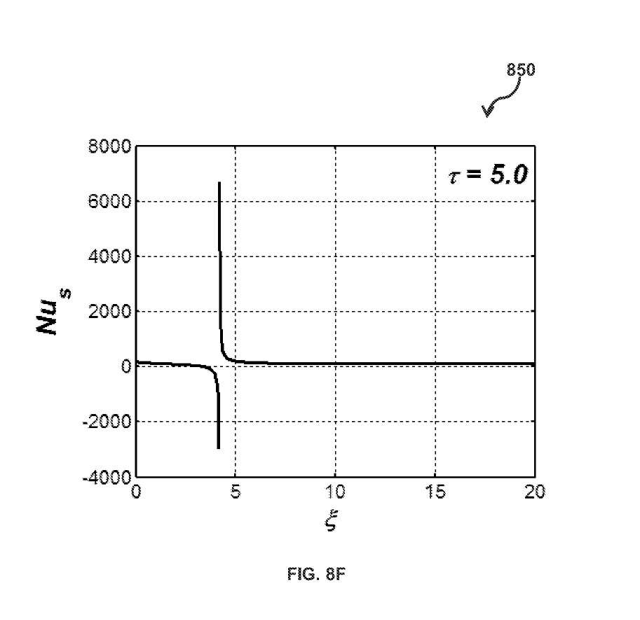

The Nusselt numbers for fluid and solid phases are presented along the axial coordinate in FIG. 8. It can be seen that the Nusselt numbers approach infinity at a specific axial location at any given time up to approximately when the steady state conditions are reached. It is also found that, far enough downstream of the entrance, the Nusselt number becomes invariant with position. This phenomenon occurs when the dimensional wall temperature value is within the range specified by the initial and inlet temperature values. This is the reason why this phenomenon did not occur in the work of Amiri, A., Vafai, K., 1998, “Transient analysis of incompressible flow through a packed bed,” Ints. J. Heat Mass Transfer, 41, pp. 4259-4279. In their work, the wall temperature was larger than the entrance and the initial temperature. As such in their work the dimensionless average temperature did not approach a zero value. Further, it is noted this phenomenon is a manifestation of non-dimensional temperature quantities.

The fully developed temperature distributions for fluid and solid phases under steady state conditions can be derived from equations (25) and (26).

$$\begin{matrix}{θ}_{fs\_d} = \frac{2 {θ}_{in}}{{η}_{1}} exp [ - ( k {s}_{0}^{2} + 1 - \frac{1}{{s}_{0}^{2} + 1} ) ξ ] \frac{sin ( {s}_{0} {η}_{1} )}{{s}_{0}} cos ( {s}_{0} η ) & Eq . ( 37 ) \\ {θ}_{ss\_d} = \frac{2 {θ}_{in}}{{η}_{1}} exp [ - ( k {s}_{0}^{2} + 1 - \frac{1}{{s}_{0}^{2} + 1} ) ξ ] \frac{sin ( {s}_{0} {η}_{1} )}{{s}_{0} ( {s}_{0}^{2} + 1 )} cos ( {s}_{0} η ) & Eq . ( 38 )\end{matrix}$$

Further, the average fully developed temperature distributions for fluid and solid under steady state conditions can be obtained as:

$$\begin{matrix}{θ}_{fs\_d}^{a} = \frac{2 {θ}_{in}}{{η}_{1}^{2}} exp [ - ( k {s}_{0}^{2} + 1 - \frac{1}{{s}_{0}^{2} + 1} ) ξ ] \frac{1}{{s}_{0}^{2}} & Eq . ( 39 ) \\ {θ}_{ss\_d}^{a} = \frac{2 {θ}_{in}}{{η}_{1}^{2}} exp [ - ( k {s}_{0}^{2} + 1 - \frac{1}{{s}_{0}^{2} + 1} ) ξ ] \frac{1}{{s}_{0}^{2} ( {s}_{0}^{2} + 1 )} & Eq . ( 40 )\end{matrix}$$

By utilizing equations (37)-(40), the following equations is obtained:

$$\frac{{θ}_{ss\_d}}{{θ}_{ss\_d}^{a}} = \frac{{θ}_{fs\_d}}{{θ}_{fs\_d}^{a}} = \frac{π}{2} cos ( {s}_{0} η ) = \frac{{T}_{fs\_d} - {T}_{w}}{{T}_{fs\_d}^{a} - {T}_{w}} = \frac{{T}_{ss\_d} - {T}_{w}}{{T}_{ss\_d}^{a} - {T}_{w}} \qquad Eq . ( 41 )$$

As such the dimensionless fully developed temperature distributions,

$$\frac{{T}_{fs\_d} - {T}_{w}}{{T}_{fs\_d}^{a} - {T}_{w}} and \frac{{T}_{ss\_d} - {T}_{w}}{{T}_{ss\_d}^{a} - {T}_{w}} ,$$

become independent of the axial length when condition given by equation (39) is achieved. By utilizing equations (37)-(39), the fully developed Nusselt numbers for fluid and solid phases under steady state condition are obtained as:

$$\begin{matrix}{Nu}_{fs\_d} = {π}^{2} & Eq . ( 42 ) \\ {Nu}_{ss\_d} = \frac{4 {η}_{1}^{2} {π}^{2}}{k ( {π}^{2} + 4 {η}_{1}^{2} )} & Eq . ( 43 )\end{matrix}$$

Defining a total Nusselt number which is the sum of Nu_{f} and Nuₛ, we obtain

$${Nu}_{ts\_d} = {Nu}_{fs\_d} + {Nu}_{ss\_d} = \frac{4 {η}_{1}^{2} {π}^{2}}{k ( {π}^{2} + 4 {η}_{1}^{2} )} + {π}^{2} \qquad Eq . ( 44 )$$

As can be seen, the total fully developed Nusselt number under steady state condition increases with η₁, which is directly related to the Biot number, and decreases with the thermal conductivity ratio, k.

### 5. TWO PRIMARY TYPES OF HEAT FLUX BIFURCATIONS IN POROUS MEDIA

It is demonstrated the existence of two types of heat flux bifurcations in a porous media. The first type is the same as the one discussed by Yang, K., Vafai, K., 2010, “Analysis of temperature gradient bifurcation in porous media—an exact solution,” Int. J. Heat Mass Transfer, 53, pp. 4316-4325. For the second type of heat flux bifurcation we start with representation of the total heat flux at the wall as:

$${q}_{w} = - {{k}_{f , eff} ( \frac{\partial {T}_{f}}{\partial y} )}_{y = H} - {{k}_{s , eff} ( \frac{\partial {T}_{s}}{\partial y} )}_{y = H} \qquad Eq . ( 45 )$$

The dimensionless total heat flux at the wall is obtained from:

$${Ω}_{w} = \frac{{q}_{w}}{( {T}_{0} - {T}_{w} ) \sqrt{{k}_{s , eff} {h}_{i} α}} = - {k ( \frac{\partial {θ}_{f}}{\partial η} )}_{η = {η}_{1}} - {( \frac{\partial {θ}_{s}}{\partial η} )}_{η = {η}_{1}} \qquad Eq . ( 46 )$$

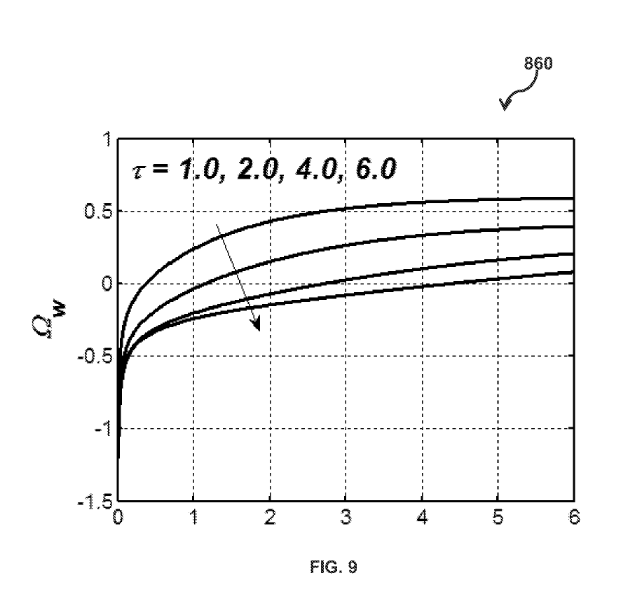

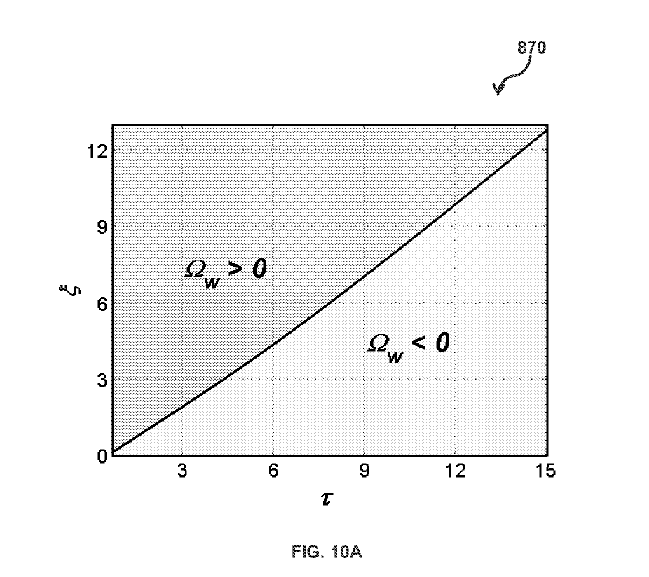

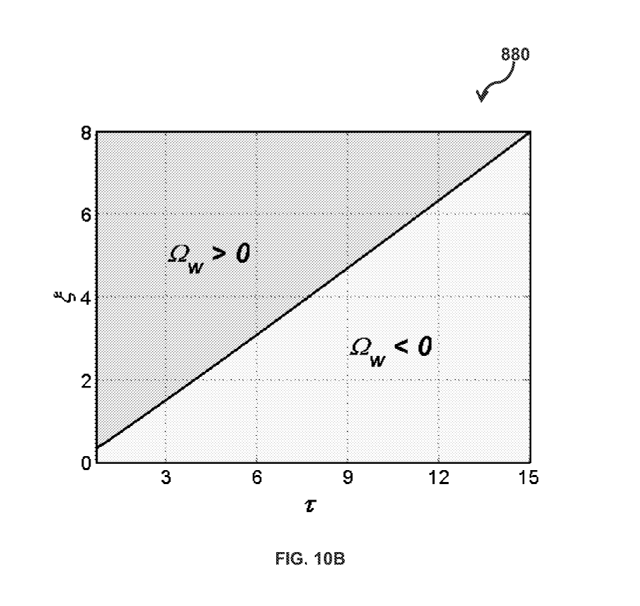

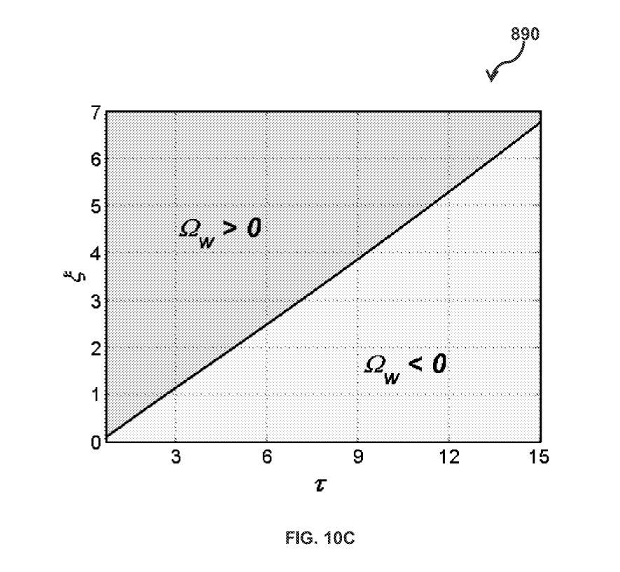

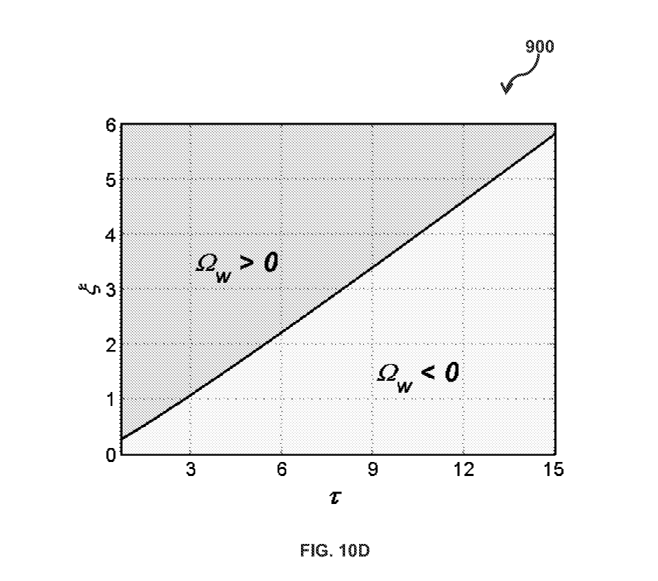

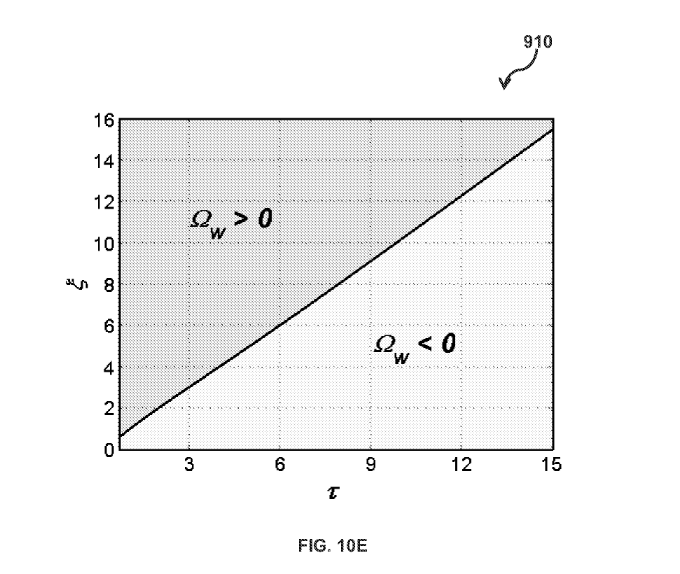

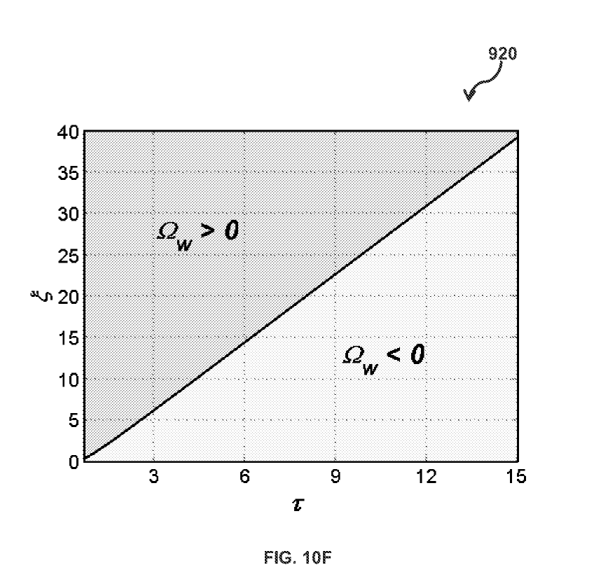

The dimensionless total heat flux at the wall for k=0.1, β=0.02, η₁=5, and θᵢₙ=−0.4 is shown in FIG. 9. It is found that the direction of total heat flux changes along the channel. This leads to a different type of heat flux bifurcation. This bifurcation must be taken into account for various applications, where there is a need to maintain a constant temperature boundary condition. As shown in FIG. 10, the total heat flux bifurcation region changes with time and is dependent on the pertinent parameters k, β, η₁, and θᵢₙ. Note that this type of bifurcation phenomenon only occurs during the transient process. The interface line between the regions Ω_{w}>0 and Ω_{w}<0 represents the location for Ω_{w}=0, which moves downstream with time. The speed which the bifurcation region moves downstream increases as either k, β, η₁, or θᵢₙ decreases. When q_{w}=0, the heat exchange between the solid and fluid phases through thermal conduction at the wall is obtained from:

$${Q}_{o} = \vert - {{k}_{f , eff} ( \frac{\partial {T}_{f}}{\partial y} )}_{y = H} \vert = \vert {{k}_{s , eff} ( \frac{\partial {T}_{s}}{\partial y} )}_{y = H} \vert \qquad Eq . ( 47 )$$

The integrated internal heat exchange between the solid and fluid phases can be calculated from:

Qᵢ=|∫₀^{H}hᵢα(Tₛ−T_{f})dy|=|hᵢαH(T₀−T_{w})(θₛ^{a}−θ_{f}^{a})| Eq. (48)

The corresponding heat exchange ratio is defined as:

$$γ = \frac{{Q}_{o}}{{Q}_{i} + {Q}_{o}} \qquad Eq . ( 49 )$$

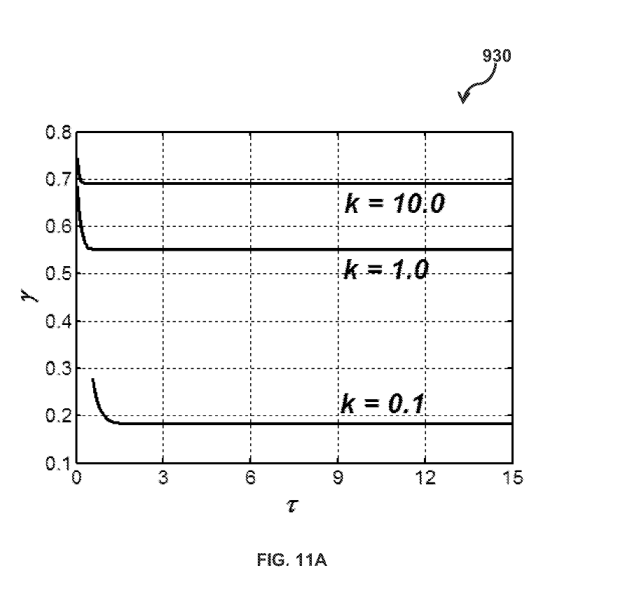

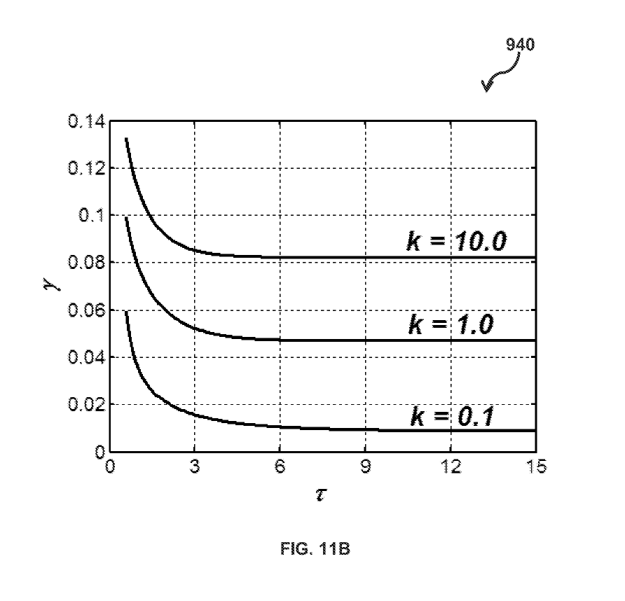

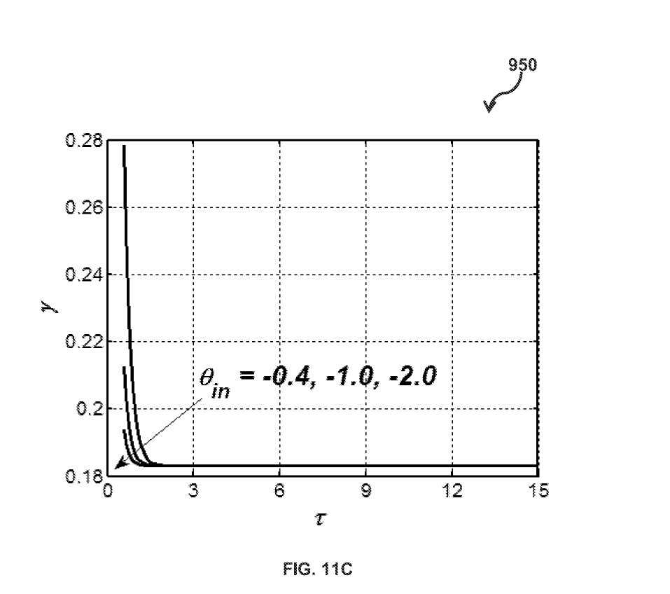

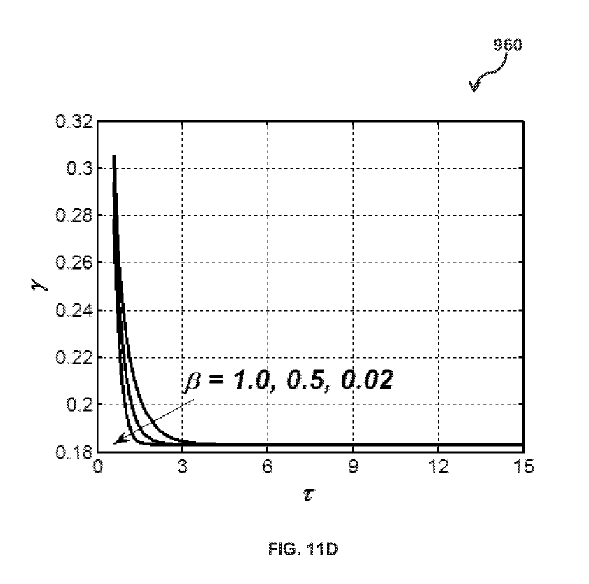

The heat exchange ratio variations as a function of parameters η₁, k, θᵢₙ, and β for q_{w}=0 are shown in FIG. 11. It is found that the heat exchange ratio is mostly dependent on η₁ and k, whereas θᵢₙ and β have little influence on the heat exchange ratio. The heat exchange between solid and fluid phases through the thermal conduction at the wall is more prominent for small η₁ and large k. When η₁=1 and k=10, up to 68% of total heat exchange between solid and fluid phases within the bifurcation region is through thermal conduction at the wall. Note that the temporal variations of the heat exchange ratio displays two distinct regimes. During the initial stage, the heat exchange ratio decreases sharply with time, while for the later stage, the heat exchange ratio remains almost unchanged.

When q_{w}≠0, for the region where the first type of heat flux bifurcation occurs, the heat exchange between the solid and fluid phases through the thermal conduction at the wall can be represented as:

$${Q}_{o} = min \{ \vert - {{k}_{f , eff} ( \frac{\partial {T}_{f}}{\partial y} )}_{y = H} \vert , \vert - {{k}_{s , eff} ( \frac{\partial {T}_{s}}{\partial y} )}_{y = H} \vert \} for {( \frac{\partial {T}_{f}}{\partial y} )}_{y = H} {( \frac{\partial {T}_{s}}{\partial y} )}_{y = H} < 0 \qquad Eq . ( 50 )$$

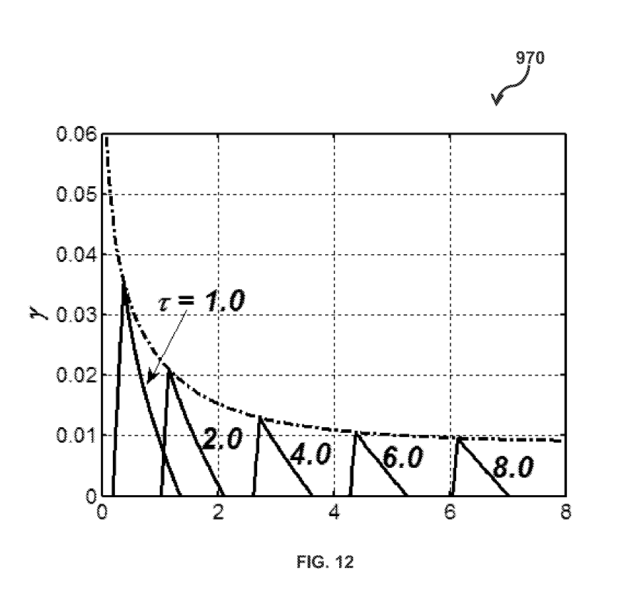

The corresponding heat exchange ratio for q_{w}≠0 is also calculated using equation (49), and shown in FIG. 12. The dashed line in FIG. 12 represents the maxima loci of the heat exchange ratio. Comparing FIGS. 10(a), 11(b), and 12, it is found that this dashed line is identical to the corresponding curve for k=0.1 shown in FIG. 11(b), which implies that the heat exchange ratio for q_{w}≠0 is always smaller than the corresponding one for q_{w}=0.

As an example, the dimensional characteristic time was calculated for sandstone while the working fluid is air. The following physical data were used:

Tᵢₙ=300K, T_{w}=310K, Tₒ=335K, H=0.05 m, dₚ=5 mm, ε=0.391

### Air:

ρ_{f}=1.1614 kg/m³, c_{f}=1007 J/kg·K, k_{f}=0.0263 W/m·K, μ=1.846×10⁻⁵ kg/m·s
From Schumann, T. E. W., 1929, “Heat transfer: liquid flowing through a porous prism, J. Franklin Inst.,” 208. pp. 405-416:
ρᵢ=2200 kg/m³, cₛ=710 J/kg·K, kₛ=1.83 W/m·K
The particle Reynolds number is defined as:

$${Re}_{p} = \frac{{ρ}_{f} u {d}_{p}}{μ} \qquad Eq . ( 51 )$$

The interstitial heat transfer coefficient is expressed as Alazmi, B., and Vafai, K., 2002, “Constant Wall Heat Flux Boundary Conditions in Porous Media under Local Thermal Non-Equilibrium Conditions,” Int. J. Heat Mass Transfer, 45, pp. 3071-3087.

$${h}_{i} = \frac{{k}_{f}}{{d}_{p}} [ 2 + 1.1 {{Pr}^{1 / 3} ( \frac{{ρ}_{f} u {d}_{p}}{μ} )}^{0.6} ] \qquad Eq . ( 52 )$$

The interfacial area per unit volume of the porous medium is calculated as:

$$α = \frac{6 ( 1 - ɛ )}{{d}_{p}} \qquad Eq . ( 53 )$$

Effective thermal conductivity of the fluid and solid phases of porous media are represented by:

k_{f,eff}=εk_{f} Eq. (54)

k_{s,eff}=(1−ε)kₛ Eq. (55)

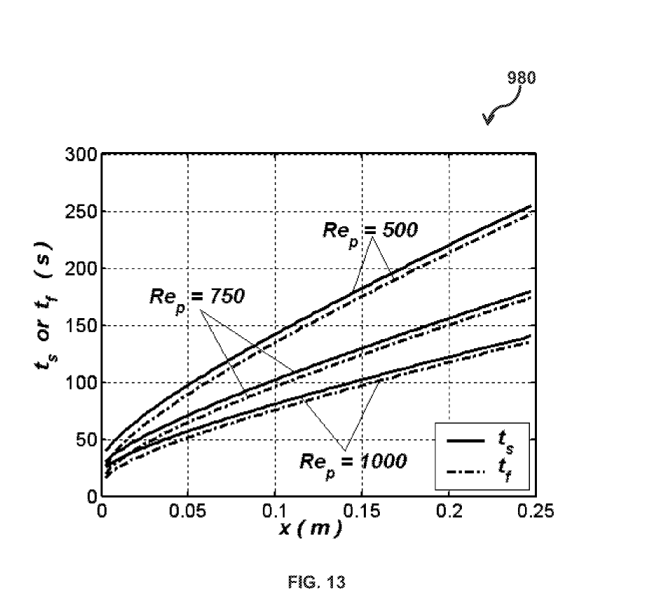

It can be seen from FIG. 13 that increasing Reₚ can reduce the dimensional characteristic time for both the fluid and solid phases. However, the correlation between the dimensional characteristic time and Reₚ is nonlinear.

### 6. CONCLUSIONS

Transient heat transfer in a packed bed subject to a constant temperature boundary condition is investigated analytically. A transient LTNE model which incorporates diffusion in both the solid and fluid phases is employed to represent heat transport. Exact solutions for transient solid and fluid temperature distributions as well as steady solid and fluid temperature distributions are derived. Exact solutions of fluid, solid, and total Nusselt number for fully developed region under steady state condition are also obtained. The results show a substantial two-dimensional thermal behavior for the solid and fluid phases, and the LTE model is found to be unsuitable to describe the transient heat transfer process in a porous media. The phenomenon of heat flux bifurcation for the solid and fluid phases at the wall is found to occur over a given axial region at a given time frame. Heat flux bifurcation is also found to occur along the channel. The bifurcation region moves downstream with time and is dependent on the pertinent parameters k, β, and θᵢₙ. The non-dimensional axial length scale, ξ, introduced earlier can be used to represent the indirect integrated influences of Darcy and particle Reynolds numbers on the temperature difference between the solid and fluid phases. Thermal conduction at the wall is found to play an important role on the total exchange between the solid and fluid phases within heat flux bifurcation region, especially for small η₁ and large k. When

$$ξ > \frac{τ}{β} ,$$

it is found that the heat transfer can be described using the LTNE model with no convection in the fluid phase energy equation. A characteristic time is introduced to evaluate the time that it takes for either the solid or fluid to reach steady state. This characteristic time is found to increase with an increase in k, β, η₁ or θᵢₙ.

It will be appreciated that variations of the above disclosed apparatus and other features and functions, or alternatives thereof, may be desirably combined into many other different systems or applications. Also, various presently unforeseen or unanticipated alternatives, modifications, variations or improvements therein may be subsequently made by those skilled in the art which are also intended to be encompassed by the following claims.

What is claimed is:

1. A method for analyzing transient thermal response of a porous medium under a local thermal non equilibrium condition, said method comprising:
analyzing heat flux bifurcation phenomenon in a porous media for temporal conditions;
deriving at least two primary types of heat flux bifurcations with respect to said porous media;
deriving a plurality of exact solutions for both a fluid temperature distribution and a solid temperature distribution over a constant temperature boundary condition;
analyzing fluid, solid, and total Nusselt numbers during a transient process;
estimating an influence of interactions between solid phases and fluid phases through thermal conduction at a wall within a heat flux bifurcation region by introducing a heat exchange ratio;
determining a region wherein heat transfer is described without considering a convection contribution in a fluid phase; and
analyzing a two-dimensional thermal behavior for said solid phases and said fluid phases.

2. The method of claim 1 further comprising evaluating characteristic time for reaching steady state conditions.

3. The method of claim 1 wherein validity of said domain over said local thermal equilibrium model is determined by investigating temporal temperature differential between the solid and fluid.
